(19) United States
(12) Patent Application Publication
(10) Pub. No.: US 2021/0271282 A1
(43) Pub. Date: Sep. 2, 2021

(54) COVER FOR AN OPERATOR CONTROL ELEMENT AND OPERATOR CONTROL ASSEMBLY

(71) Applicant: BCS AUTOMOTIVE INTERFACE SOLUTIONS GMBH, Radolfzell (DE)

(72) Inventors: SÖREN LEMCKE, Gundholzen-Gaienhofen (DE); NIKOLAJ POMYTKIN, Konstanz (DE); TIMO SCHUBERT, Bodman-Ludwigshafen (DE)

(21) Appl. No.: 17/253,218

(22) PCT Filed: Jul. 23, 2019
(86) PCT No.: PCT/EP2019/069770

§ 371 Date: Dec. 17, 2020

(30) Foreign Application Priority Data
Jul. 26, 2018 (DE) 10 208 118 115.9

(51) Int. Cl. G05G 1/02; G05G 5/03

(52) U.S. Cl. CPC G05G 1/02; G05G 5/03

(57) ABSTRACT

A cover for an operating element has a massive basic body which includes an operating surface, and at least one massive button piece for actuating the operating element, the basic body having at least one through opening which extends from the operating surface completely through the basic body. The button piece is fastened in the through opening to the basic body such that the button piece is movable in the axial direction and is flush with the operating surface in the unactuated state. An operating assembly is furthermore shown.

### RELATED APPLICATIONS

This application filed under 35 U.S.C. § 371 is a national phase application of International Application Serial Number PCT/EP2019/069770, filed Jul. 23, 2019, which claims the benefit of German Application No. 10 2018 118 115.9 filed Jul. 26, 2018, the subject matter of which are incorporated herein by reference in their entirety.

### FIELD OF THE DISCLOSURE

The disclosure relates to a cover for an operating element and to an operating assembly having at least one operating element.

### BACKGROUND

Operating assemblies having operating elements must usually not only function technically faultlessly, but must also satisfy optical aspects. Operating assemblies are furthermore often arranged above a display to create a combined input/output device.

For this reason, glass or another transparent solid material is often used as a cover for an operating element. However, this is disadvantageous as glass or another solid material is rigid and therefore makes haptic feedback when operating the operating assembly difficult.

### SUMMARY

Thus, there is a need to provide a cover for an operating element and an operating assembly in which a solid material is used as a cover but at the same time permits haptic feedback during operation.

For this purpose, a cover for an operating element is provided, having a massive basic body which includes an operating surface, and at least one massive button piece for actuating the operating element. The basic body has at least one through opening which extends from the operating surface completely through the basic body, and the button piece is fixed in the through opening to the basic body such that the button piece is movable in the axial direction and is flush with the operating surface in the unactuated state.

The movable mounting of the button piece with respect to the basic body provides haptic feedback for the operator, as he feels the movement of the button piece with respect to the basic body. The operator therefore knows that he has hit a specific point on the operating surface.

In the context of the disclosure, a massive body is understood to be a body made of a solid material. For example, the through opening is perpendicular to the operating surface.

The operating surface may be flat.

Preferably, the basic body and/or the button piece are made of glass, a transparent plastic material such as plexiglass, metal, ceramic, wood or another rigid solid material. Therefore, the cover may be transparent.

In one configuration of the disclosure, a bearing ring is provided between the button piece and a wail of the through opening, which fastens the button piece in the through opening, a fastening being thus permitted in an easy manner.

The button piece is for example held only by the bearing ring.

To not impair the function of the cover or to allow movement, the bearing ring is transparent and/or made of an elastic material, in particular an elastomer. The elastomer may be silicone.

In one variant embodiment, the bearing ring is flush with the operating surface, which improves the quality of the operating surface.

In order to cover a surface which is as large as possible, the basic body may be a plate.

In one variant embodiment, the button piece has the same thickness in the axial direction as the basic body, The cover can thus be produced in an easy manner.

In one embodiment of the disclosure, the through opening has a cross-sectional geometry, the cross-sectional geometry of the button piece corresponding at least in sections to the cross-sectional geometry of the through opening, in particular being reduced in size compared to the cross-sectional geometry of the through opening. The button piece can thus close the most part of the cross-section of the through opening,

For example, the cross-sectional geometry of the button piece is completely reduced. The button piece can additionally or alternatively be configured to be cylindrical.

In a further embodiment of the disclosure, the button piece has an upper section and a lower section, the cross-sectional geometry of the upper section being substantially identical to the cross-sectional geometry of the through opening, and the lower section having a smaller diameter than the upper section. This allows the distance between the wall of the through opening and the upper section of the operating surface to be reduced, which further improves the quality of the operating surface. For example, the bearing ring engages the lower section.

The button piece may be mushroom-shaped.

Furthermore, the object is achieved by an operating assembly having at least one operating element and a cover according to the disclosure, the operating element, in particular on the side facing away from the operating surface, being provided in the area of the button piece.

For example, the button piece is arranged with respect to the operating element such that the operating element is actuated when the button piece is moved.

Preferably, the operating element is a button piece or at least part of a touch-sensitive layer. The operating element can thus be designed in a cost effective manner.

### BRIEF DESCRIPTION OF THE DRAWINGS

Further features and advantages of the disclosure will become apparent from the description below and from the attached drawings to which reference is made and in which:

FIGS. 1a and 1b show an operating assembly according to the disclosure including a cover according to the disclosure in a sectional view and in a top view, respectively,

FIG. 2 shows the operating assembly of FIG. 1 in a perspective view, and

FIGS. 3a and 3b show a second embodiment of an operating assembly according to the disclosure including a cover according to the disclosure in a sectional view and in a top view, respectively.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C”. The same holds true for listings with more than two items.

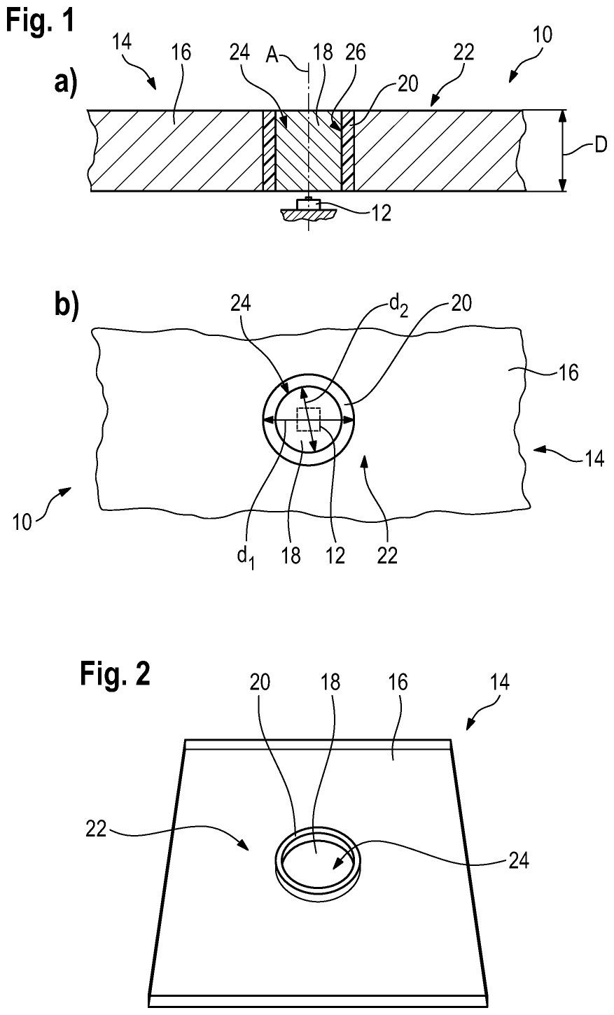

FIGS. 1a and 1b show an operating assembly 10 including an operating element 12 and a cover 14 for the operating element 12 in a sectional view and in a side view, respectively. FIG. 2 shows the operating assembly 10 in a perspective view.

The cover 14 comprises a basic body 16, a button piece 18 and a bearing ring 20.

In the example embodiment shown, the basic body 16 is a plate made of a massive solid material such as glass, which has two flat, parallel surfaces, Alternatively, the basic body 16 may be made of a transparent plastic material.

The basic body 16 and/or the button piece 18 can of course also be made of metal, ceramic, wood or another rigid solid material.

The surface of the basic body 16 facing the operator of the operating assembly 10 forms the operating surface 22 of the cover 14.

A through opening 24 which extends through the entire thickness D of the basic body 16 is formed in the basic body 16, in particular perpendicular to the operating surface 22, The through opening 24 defines an axial direction A.

The through opening 24 includes a wall 26 and has a cross-sectional geometry that can be seen in FIG. 1b. In the example embodiment shown, this is a circle having a diameter d₁.

The button piece 18, which is made of glass in a massive manner like the basic body 16 is provided in the through opening 24.

The button piece 18 has the same thickness D as the basic body 16, i.e. in the axial direction of the through opening 24, the basic body 16 and the button piece 18 have the same length.

In the example embodiment shown, the button piece 18 is cylindrical and therefore has a cross-sectional geometry which is also a circle.

However, the cross-sectional geometry of the button piece 18 is reduced with respect to the cross-sectional geometry of the through opening 24, i.e. the diameter d₂ of the button piece 18 is smaller than the diameter d₁ of the through opening 24.

Since the button piece 18 is cylindrical, the cross-sectional geometry of the button piece 18 is completely smaller than the cross-sectional geometry of the through opening 24.

The reduced diameter d₂ of the button piece 18 produces a gap between the wall 26 of the through opening 24 and the button piece 18 in which the bearing ring 20 is located.

The button piece 18 is held in the through opening 24 by the bearing ring 20. In particular, the bearing ring 20 is the only attachment of the button piece 18.

The bearing ring 20 is made of an elastic material, e.g. an elastomer such as silicone. The bearing ring 20 can for example be made of a transparent material.

Due to the elasticity of the bearing ring 20, the button piece 18 is movable in the through opening 24 in the axial direction of the through opening 24. The button piece 18 can thus be moved relative to the basic body 16.

In the unactuated state, i.e. without load, the button piece 18 is flush with the operating surface 22 of the basic body 16.

The bearing ring 20 can also be flush with the operating surface 22 of the basic body 16, so that a flat surface of the entire cover 14 is generally formed.

The operating element 12 in FIG. 1, a push button, is provided on the side of the cover 14 facing away from the operating surface 22 and is located in the axial direction in the area of the button piece 18, as shown in particular in FIG. 1b.

If the operator of the operating assembly 10 wants to actuate the operating element 12, he puts his finger on the operating surface 22 and presses the button piece 18 downwards, i.e. into the through opening 24.

The button piece 18 is thus shifted relative to the basic body 16 and presses the operating element 12. The operating element 12 is thus actuated as desired by the operator.

At the same time, a flat operating surface 22 made of glass is provided, which provides a haptic feedback due to the movement of the button piece 18.

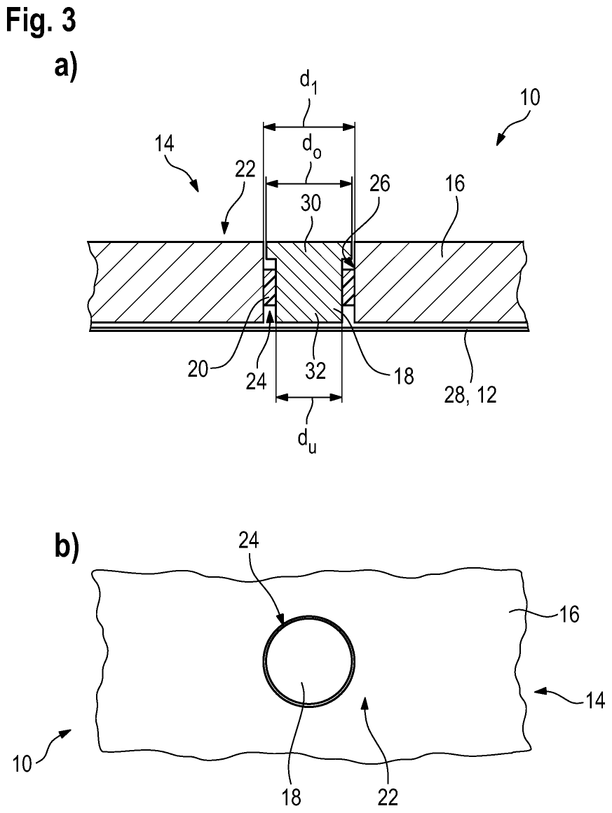

FIGS. 3a and 3b show a second embodiment of the operating assembly 10 and the cover 14 in a sectional view and in a top view, respectively, which substantially correspond to those of the first embodiment. Therefore, only the differences will be discussed below, and identical and functionally identical parts are marked with the same reference numerals.

On the one hand, the operating assembly 10 of the second embodiment differs from the operating assembly of the first embodiment in that the operating element 12 is not designed as a push button, but as a touch-sensitive layer 28.

The touch-sensitive layer 28 is provided on the side of the cover 14 which faces away from the operating surface 22, The touch-sensitive layer 28 is in particular touch-sensitive in the area of the button piece 18.

The touch-sensitive layer 28 is for example a capacitive touch-sensitive layer.

A further difference between the embodiments is the design of the button piece 18. In the second embodiment, the button piece 18 includes an upper section 30 and a lower section 32.

The upper section 30 faces the operating surface 22 and is flush therewith in the unactuated state.

Away from the operating surface 22, i,e. towards the operating element 12, the lower section 32 adjoins the upper section 30.

In the example embodiment shown, the upper section 30 and the lower section 32 both have a circular crass-sectional geometry but different diameters.

The diameter d₀ of the upper section 30 corresponds substantially to the diameter d₁ of the through opening, so that the cross-sectional geometry of the through opening 24 and of the upper section 30 are substantially identical.

Here, substantially means that there is only a very small distance of less than half a millimeter between the wall 26 of the through opening 24 and the upper section 30.

In contrast thereto, the lower section 32 has a diameter d₀ which is smaller than the diameter d₀ of the upper section 30, The gap is thus formed between the wall 26 and the lower section 32, in which the bearing ring 20 is provided as described for the first embodiment. The bearing ring 20 therefore engages the lower section 32.

The button piece 18 in this second embodiment is thus mushroom-shaped or has a T-shaped cross-section.

This results in a high-quality operating surface with only a small circular interruption of the operating surface 22 around the upper section 30.

To actuate the operating element 12, the operator again puts his finger on the operating surface 22 in the area of the button piece 18 and presses the button piece 18.

In this embodiment, the operating element 12, i.e. the touch-sensitive layer 28, is triggered by touching the button piece 18 alone, so that the movement of the button piece 18 does not contribute to actuation. The pressing of the button piece 18 merely serves as a haptic feedback for the operator to communicate that he has touched the correct position of the operating surface 22.

The features of the embodiments shown can of course be combined with each other as desired. in particular, a touch-sensitive layer 28 is conceivable as operating element 12 in the first embodiment. A push button piece may also be provided as operating element 12 in the second embodiment.
cm 1-11. (canceled)

12. A cover for an operating element having a massive basic body which includes an operating surface, and at least one massive button piece for actuating the operating element,
the basic body having at least one through opening which extends from the operating surface completely through the basic body, and
the button piece being fastened in the through opening to the basic body such that the button piece is movable in the axial direction and is flush with the operating surface in the unactuated state.

13. The cover according to claim 12, wherein at least one of the basic body and the button piece is made of glass, a transparent plastic material, metal, ceramic, wood or another rigid solid material.

14. The cover according to claim 13, wherein a bearing ring which fastens the button piece in the through opening is provided between the button piece and a wall of the through opening.

15. The cover according to claim 14, wherein the bearing ring is at least one of transparent and made of an elastic material.

16. The cover according to claim 15, wherein the bearing ring is made of an elastomer.

17. The cover according to claim 15, wherein the bearing ring is flush with the operating surface.

18. The cover according to claim 12, wherein the basic body is a plate.

19. The cover according to claim 12, wherein in axial direction, the button piece has the same thickness as the basic body.

20. The cover according to claim 12, wherein the through opening has a cross-sectional geometry, the cross-sectional geometry of the button piece corresponding at least in sections to the cross-sectional geometry of the through opening.

21. The cover according to claim 20, wherein the cross-sectional geometry of the button piece is reduced with respect to the cross-sectional geometry of the through opening.

22. The cover according to claim 20, wherein the button piece has an upper section and a lower section, the cross-sectional geometry of the upper section being substantially identical to the cross-sectional geometry of the through opening, and the lower section having a smaller diameter than the upper section.

23. An operating assembly including at least one operating element and a cover, the cover for the operating element having a massive basic body which includes an operating surface, and at least one massive button piece for actuating the operating element, the basic body having at least one through opening which extends from the operating surface completely through the basic body, and the button piece being fastened in the through opening to the basic body such that the button piece is movable in the axial direction and is flush with the operating surface in the unactuated state, wherein the operating element is provided in the area of the button piece.

24. The operating assembly according to claim 23, wherein the operating element is provided in the area of the button piece on the side facing away from the operating surface.

25. The operating assembly according to claim 23, wherein the operating element is a button or at least part of a touch-sensitive layer.
